(19) United States
(12) Patent Application Publication
(10) Pub. No.: US 2017/0348740 A1
(43) Pub. Date: Dec. 7, 2017

(54) METHODS AND APPARATUS TO TREAT WORKPIECES

(71) Applicant: Dürr Ecoclean GmbH, Filderstadt (DE)

(72) Inventors: Egon Käske, Aachen (DE); Alexander Genze, Simmerath (DE)

(21) Appl. No.: 15/684,715

(22) Filed: Aug. 23, 2017

Related U.S. Application Data
(63) Continuation-in-part of application No. PCT/EP2016/050086, filed on Jan. 5, 2016.

(30) Foreign Application Priority Data
Feb. 24, 2015 (DE) 102015203323.6

(51) Int. Cl. B08B 9/00; B08B 7/02; F02F 7/00

(52) U.S. Cl. CPC B08B 9/00; B08B 7/028; B08B 2209/005; F02F 2200/06; F02F 7/0095

(57) ABSTRACT

Methods and apparatus to treat workpieces are disclosed. A disclosed example equipment is to treat a workpiece with a process fluid, where the workpiece has a workpiece body with at least one cavity that extends from a first opening to a second opening. The example equipment includes a line system for providing the process fluid, where the line system has at least one line duct with an adapter for connecting the line system to the at least one cavity, a process chamber to receive the workpiece in treatment, where the process chamber includes an outlet to discharge a process fluid that has been induced into the cavity, and a suction installation to generate negative pressure, where the suction installation is connected to the process chamber by a suction duct to suction the process fluid from a fluid vessel through the at least one line duct and the at least one cavity into the process chamber.

### RELATED APPLICATION

This patent arises as a continuation-in-part of International Patent Application No. PCT/EP2016/050086, which was filed on Jan. 5, 2016, which claims priority to German Patent Application No. 10 2015 203 323, which was filed on Feb. 24, 2015. The foregoing International Patent Application and German Patent Application are hereby incorporated herein by reference in their entireties.

### FIELD OF THE DISCLOSURE

This disclosure relates generally to manufacturing processes, and, more particularly, to methods and apparatus to treat workpieces.

### BACKGROUND

Dirt particles, such as shavings, dust, casting sand, liquid drops, etc., can compromise or hinder the functionality of industrially made products, such as injection nozzles of internal combustion engines, for example. The cleanliness of workpieces in industrial production processes is, thus, of great importance. Therefore, sets of equipment to treat workpieces in which the workpieces are cleaned and deburred are employed in industrial manufacturing. The workpieces in such cleaning equipment are impinged with a process fluid (e.g., with water) that is preferably provided with cleaning additives, or a liquid that contains hydrocarbons.

### BRIEF DESCRIPTION OF THE DRAWINGS

FIG. 1 illustrates a first example apparatus to treat a workpiece with a process fluid, where the workpiece has at least one cavity that extends from a first opening to a second opening, in a first operating state.

FIG. 2 illustrates the first example apparatus in a second operating state that is different from the first operating state of FIG. 1.

FIG. 3 illustrates the first example apparatus in a third operating state that is different from the first and the second operating states.

FIG. 4 illustrates a second example apparatus to treat a workpiece with a process fluid, where the workpiece has at least one cavity that extends from a first opening to a second opening.

FIG. 5 illustrates a third example apparatus to treat a workpiece with a process fluid, where the workpiece has at least one cavity that extends from a first opening to a second opening.

FIG. 6 illustrates a fourth example apparatus to treat a workpiece with a process fluid, where the workpiece has at least one cavity that extends from a first opening to a second opening.

FIG. 7 illustrates a fifth example apparatus to treat a workpiece with a process fluid, where the workpiece has at least one cavity that extends from a first opening to a second opening.

FIG. 8 illustrates a sixth example apparatus to treat a workpiece with a process fluid, where the workpiece has at least one cavity that extends from a first opening to a second opening.

The figures are not to scale. Instead, to clarify multiple layers and regions, the thickness of the layers may be enlarged in the drawings. Wherever possible, the same reference numbers will be used throughout the drawing(s) and accompanying written description to refer to the same or like parts. As used in this patent, stating that any part is in any way positioned on (e.g., positioned on, located on, disposed on, or formed on, etc.) another part, indicates that the referenced part is either in contact with the other part, or that the referenced part is above the other part with one or more intermediate part(s) located therebetween. Stating that any part is in contact with another part means that there is no intermediate part between the two parts.

### DETAILED DESCRIPTION

Methods and apparatus to treat workpieces are disclosed. The examples disclosed herein relate to equipment to treat a workpiece with a process fluid, where the workpiece includes a workpiece body having at least one cavity that extends from a first opening to a second opening. The example equipment includes a line system for providing the process fluid, where the line system has at least one line duct having an adapter for connecting the line system to the at least one cavity. The examples disclosed herein also relate to methods to treat a workpiece with a process fluid, where the workpiece body has at least one cavity that extends from a first opening to a second opening.

Dirt particles (e.g., shavings, dust, casting sand, liquid drops, etc.) can compromise or hinder the functioning of industrially-produced products, such as injection nozzles to be implemented in internal combustion engines, for example. The cleanliness of workpieces in industrial production processes is, thus, of great importance. Accordingly, equipment to treat workpieces in which the workpieces are cleaned and/or deburred are employed in industrial manufacturing. The workpieces in such cleaning equipment are impinged with a process fluid (e.g., with water) that is preferably provided with cleaning additives, or a liquid that contains hydrocarbons, for example.

A known equipment and method of the type mentioned at the outset are described in DE 10 2005 019 285 B3, which is hereby incorporated by reference. This known equipment and method described therein serve to clean castings that are used in the construction of engines. Such castings typically include complex internal spaces and ducts. A workpiece to be cleaned according to the examples disclosed herein is cleaned by adapters that are connected to a pipe or hose line, which serves to provide the cleaning fluid into the interior of the workpiece.

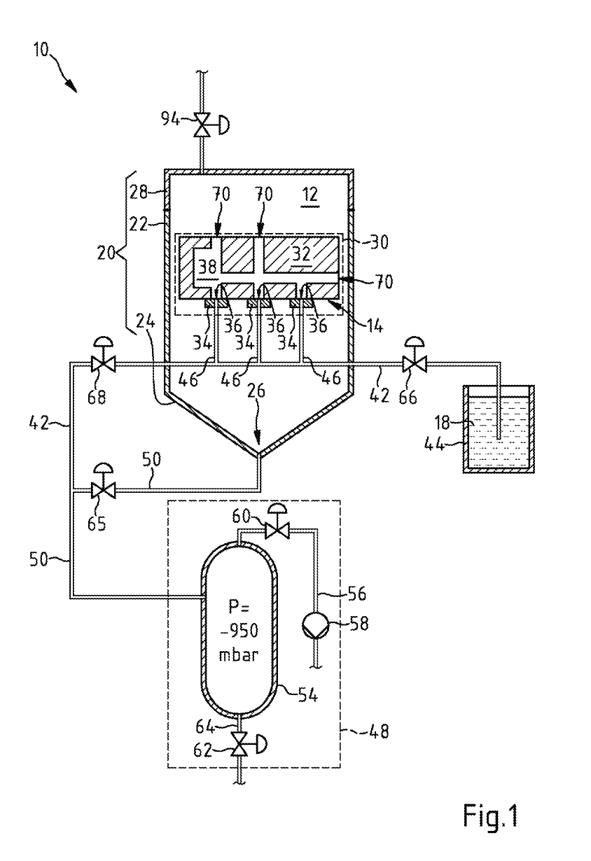

The example apparatus/equipment 10 shown in FIG. 1 to treat workpieces 14 with a process fluid 18 is implemented in this example as equipment to clean the workpieces 14. The process fluid 18 in the example equipment 10 is a liquid (e.g., water, etc.). According to the illustrated example, there is a process chamber 12 to receive a workpiece 14 to be treated in the example equipment 10. In this example, the process chamber 12 is implemented as a caldron-shaped vessel 20, which includes a cylindrical side wall 22 and a funnel-shaped base 24 having an outlet 26. In this example, the caldron-shaped vessel 20 is closable by a lid 28. Further, in this example, there is a workpiece receptacle region 30 disposed in the process chamber 12.

According to the illustrated example, the line system in the example equipment 10 includes a connection duct 42 that connects a fluid vessel 44 to line ducts 46, which are connected to the adapters 34 in this example. The example equipment 10 includes a suction installation 48 that is connected to an outlet 52 of the process chamber 12 via a suction duct 50. The suction installation 48 operates to generating negative pressure within the process chamber 12, for example. The suction installation 48 of the illustrated example includes a vacuum vessel 54 and an evacuation device 58 with a vacuum pump. In this example, the evacuation device 58 is coupled to the vacuum vessel 54 via a suction line 56. A shut-off valve 60 by which the suction line 56 can be selectively shut off and released to couple the evacuation device 58 to the vacuum vessel 54, or to separate the evacuation device 58 from the vacuum vessel 54 is disposed in the suction line 56 in this example. The example vacuum vessel 54 to discharge process fluid 18 includes an outlet 64 that is closable via a shut-off valve 62.

The connection duct 42 of the illustrated example opens into the suction duct 50 of the example equipment 10. A first adjustable valve 66 and an additional adjustable valve 68, both of which can be controlled by a computer unit (not shown) and are disposed in the connection duct 42 in this example. The flow path for process fluid 18 from the fluid vessel 44 to the line ducts 46 with the adapter 34, which is adapted to the workpiece body 32, can be selectively released and shut-off by the first adjustable valve 66 in some examples. The example second adjustable valve 68 selectively releases and shuts off the flow path for process fluid 18 from the line ducts 46 to the vacuum vessel 54 of the suction installation 48. In this example, there is a shut-off valve 65 in the example equipment 10 to release and shut off the suction duct 50. In some examples, the caldron-shaped vessel 20 is ventilated via a ventilation valve 94.

According to the illustrated example, to treat a workpiece 14 with the process fluid 18 and to clean the workpiece 14 in the process chamber 12 of the equipment 10, in a first example step, the workpiece 14 disposed in the workpiece receptacle region 30 on the side of the first openings 36 in the process chamber 12 is coupled/attached to the adapters 34. In a second example step, the adjustable valve 68 disposed in the connection duct 42, and the shut-off valve 65 disposed in the suction duct 50 are closed. In a third example step, a negative pressure of approximately 950 millibar (mbar) is generated in the vacuum vessel 54 by opening the shut-off valve 60 and by use of the evacuation device 58, where the shut-off valve 62 is closed.

In an example fourth step, the shut-off valve 65 and the valve 66 are opened, thereby impinging the process chamber 12 abruptly with the negative pressure of the vacuum vessel 54 of the suction installation 48. Accordingly, by this negative pressure, process fluid 18 is suctioned from the fluid vessel 44 through the line ducts 46 and the adapters 34 via the openings 36 of the workpiece body 32 into the cavity 38, which is configured therein. In this example, the process fluid 18 that is suctioned into the cavity 38 reaches the interior of the process chamber 12 through the openings 70, which are not covered by the adapters 34 in this example.

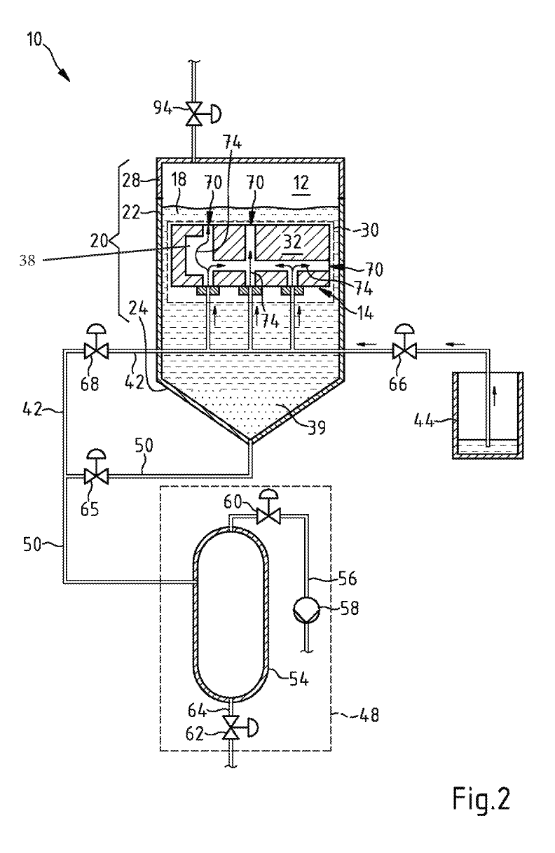

FIG. 2 illustrates the example equipment 10 in an operating state different from that shown in FIG. 1. In particular, process fluid 18 from the fluid vessel 44 is suctioned into the process chamber 12 through the openings 36 and the cavity 38 of the workpiece 14. To adjust this operating state, the valve 68 of the example equipment 10 is closed in a fourth example step. According to the illustrated example, the process fluid 18 moving in the flow direction that is generally indicated by the arrows 74 then flows through the cavity 38 into the process chamber 12. As a result, dirt particles and contaminants 39 that are deposited onto the walls of the cavity 38 are detached by the process fluid 18 and rinsed into the process chamber 12.

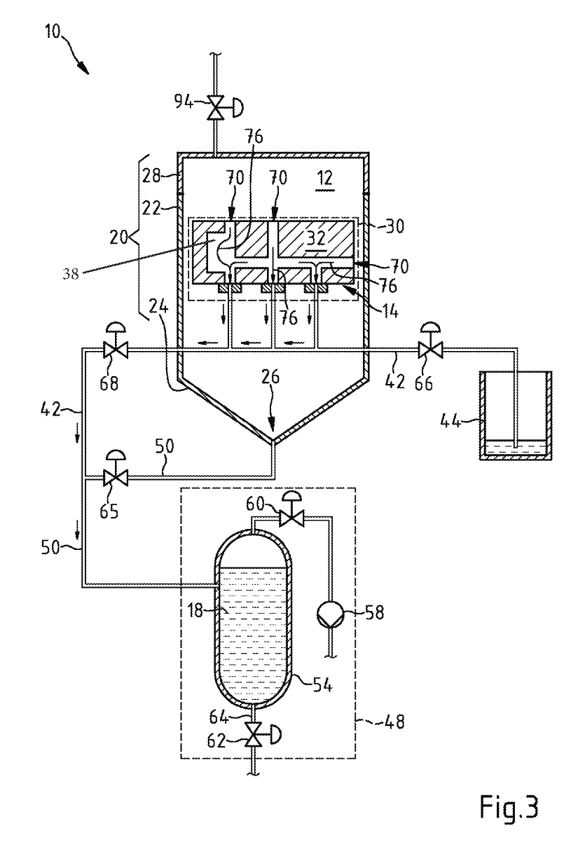

FIG. 3 illustrates the example equipment 10 in an additional example operating state that is different from the operating states shown in FIGS. 1 and 2. To adjust this operating state, the shut-off valve 65 disposed in the suction duct 50 is shut-off again in a fifth example step. Further, in this example, the valve 66 in the connection duct 42 is closed, and the valve 68 disposed in the connection duct 42 is opened. According to the illustrated example, the process fluid 18 from the process chamber 12, which is filled with the process fluid 18 via the suction installation 48, and in the flow direction that is generally indicated by the arrows 76 is then suctioned through the cavity 38 in the workpiece body 32 of the workpiece 14, and moved into the vacuum vessel 54 of the suction installation 48.

In this example, the flow direction of the process fluid 18 is counter to the flow direction of the operating state of the example equipment 10, as shown in FIG. 2 and generally identified by the arrows 76. As a result, dirt particles and contaminants that are deposited on the walls of the cavity 38 are again detached by the process fluid 18 and, thus, flow toward the vacuum vessel 54.

In a sixth example step, the process fluid 18 that has accumulated in the vacuum vessel 54 is then discharged from the vacuum vessel 54 of the suction installation 48 when the shut-off valve 62 in the outlet 64 is opened. In this example, the shut-off valve 60 is closed.

To treat or clean a workpiece with the process fluid 18, the aforementioned steps can optionally be repeated multiple consecutive times, for example.

According to the illustrated example, by having the lid 28 of the process chamber opened, the workpiece 14 is then retrieved from the process chamber 12 so that a further respective workpiece can then be treated in the process chamber 12.

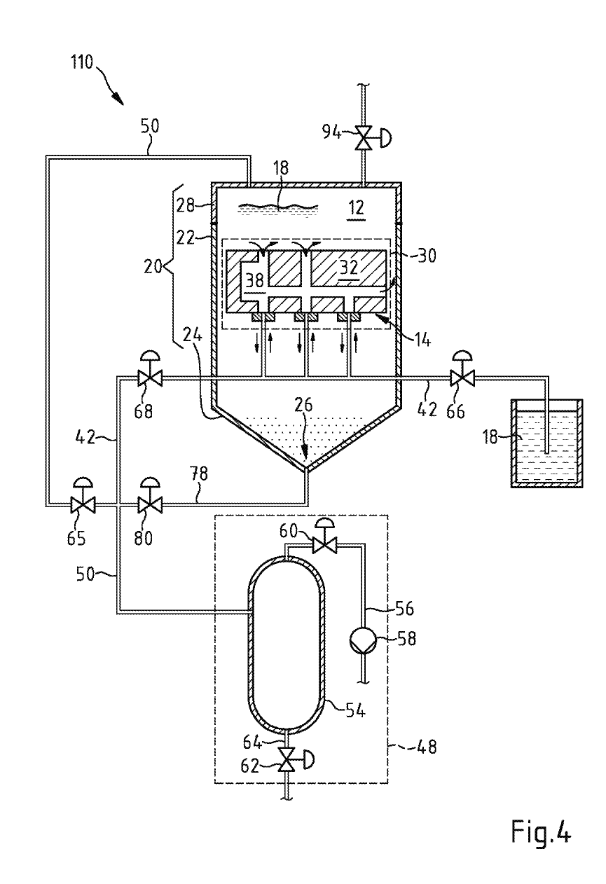

FIG. 4 shows a second example equipment 110 to treat a workpiece 14. In as far as the functional groups and elements shown in FIG. 4 in terms of functioning are equivalent to the functional groups and elements shown in FIGS. 1 to 3, said functional groups and elements are in each case identified there by the same numeral number in terms of the reference indicator.

In the example equipment 110, the suction duct 50 to apply negative pressure to the process chamber 12 opens into the portion of the lid 28. The equipment 110 of the illustrated example includes a line duct 78 with a shut-off valve 80 through which a process fluid 18 can be moved from the process chamber 12 into the vacuum vessel 54. To produce negative pressure in the process chamber 12, the shut-off valve 65 is opened when the vacuum vessel 54 of the evacuation device 58 has been evacuated, for example. The adjustable valves 66, 68 are closed herein. Further, the shut-off valve 80 in the line duct 78 is also shut off.

According to the illustrated example, opening the valve 66 causes a process fluid 18 to flow from the fluid vessel 44 through the cavity 38 of the workpiece 14 into the process chamber 12. In this example, the shut-off valve 65 and the valve 66 are shut off when the process chamber 12 has been filled with process fluid 18. The valve 68 is then opened to cause process fluid 18, by way of a flow direction that is counter to the flow direction when flowing into the process chamber 12, flows to the vacuum vessel 54 of the suction installation 48 by way of the connection duct 32 and the suction duct 50.

It is to be noted that the valve 68 and the shut-off valve 80 to suction process fluid 18 from the process chamber 12 can be opened and closed in a mutually temporally offset manner. For example, the valve 68 can be opened before the shut-off valve 80 to, thus, cause suctioning of the process fluid 18 through the cavity 38 of the workpiece body 32 of the workpiece 14. The valve 68 is then closed to cause the process fluid that is loaded with dirt particles to then be suctioned though the outlet 26 of the vessel 20 by the suction installation 48.

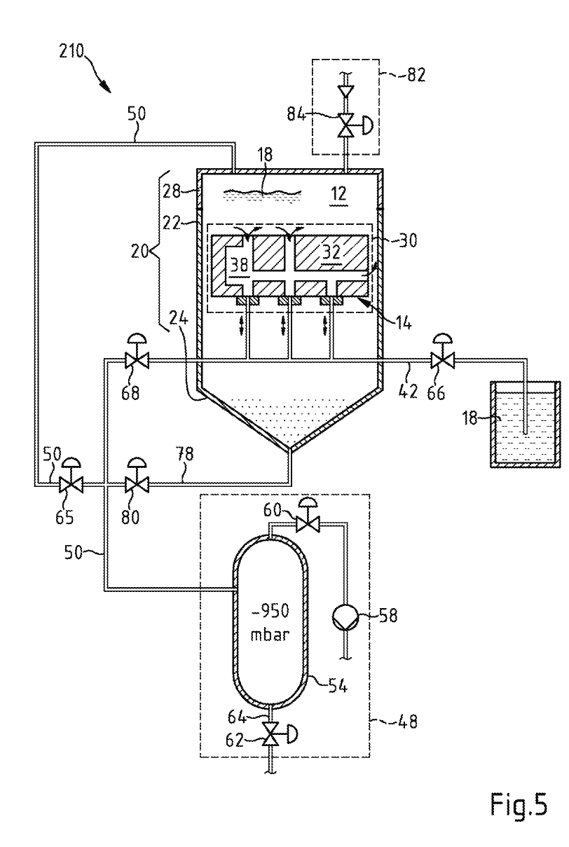

FIG. 5 shows a third example equipment 210 to treat a workpiece 14. In as far as the functional groups and elements shown in FIG. 5 in terms of functioning are equivalent to the functional groups and elements shown in FIGS. 1 through 4, the functional groups and elements are in each case identified by the same numeral in terms of the reference indicator.

In this example, there is an installation 82 to provide compressed air to the process chamber 12 to be impinged with compressed air moving through a valve 84 in the example equipment 210. The installation 82 enables a process fluid 18 that has accumulated in the process chamber 12 to be urged out by compressed air, for example, when the valves 65, 66, 68 are closed while the valve 80 is opened, or when the valves 65, 66 and the shut-off valve 80 are closed while the valve 68 is opened.

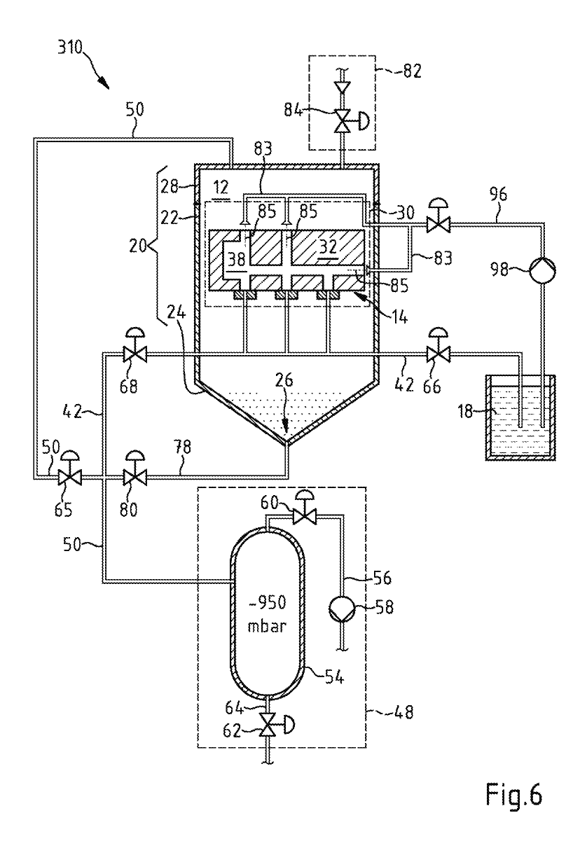

FIG. 6 shows a fourth example equipment 310 to treating a workpiece 14. In as far as the functional groups and elements shown in FIG. 6 in terms of functioning are equivalent to the functional groups and elements shown in FIGS. 1 to 5, the functional groups and elements are in each case identified there by the same numeral in terms of the reference indicators.

The example equipment 310 includes an installation 83 for impinging the at least one cavity 38 in the workpiece 14 with a process fluid 18 from a nozzle 86 by way of at least one nozzle jet 85. It is to be noted that the nozzle jet 85 in an alternative embodiment can also be composed of an additional liquid, fluid, in particular, a gaseous medium that is different from the process fluid 18. According to the illustrated example, the nozzle jet 85 can be a steam jet, for example. Moreover, the nozzle jet 85 can, in principle, be at least partially composed of ice pellets or other abrasives.

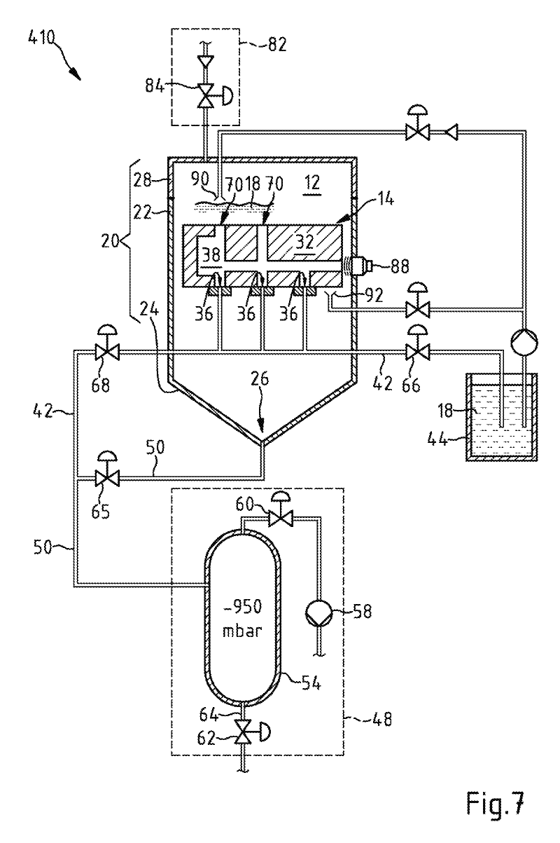

FIG. 7 shows a fifth example equipment 410 for treating a workpiece 14. In as far as the functional groups and elements shown in FIG. 7 in terms of functioning are equivalent to the functional groups and elements shown in FIGS. 1 to 6, the functional groups and elements are in each case identified there by the same numeral in terms of the reference indicators.

The example equipment 410 includes an installation 88 to impinge the at least one workpiece 14 in the process chamber 12 using ultrasound signals. Further, the equipment 410 includes spray nozzles 90 and flooding nozzles 92 to impinge the workpiece 14 with process fluid 18 from the fluid vessel 44 via a line 96 by way of a conveying pump 98 in the equipment 410.

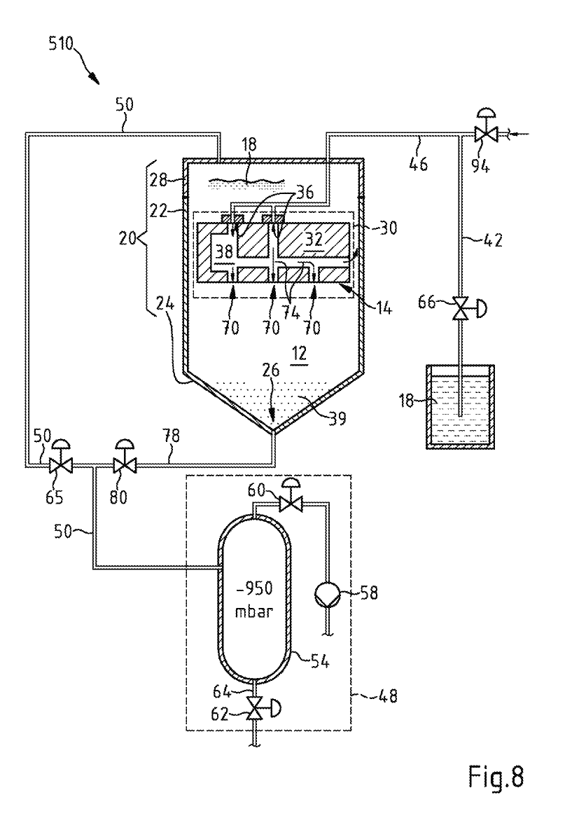

FIG. 8 shows a sixth example equipment 510 to treat a workpiece 14. In as far as the functional groups and elements shown in FIG. 8 in terms of functioning are equivalent to the functional groups and elements shown in FIG. 1 to FIG. 7, said functional groups and elements are in each case identified there by the same numeral in terms of the reference sign.

The workpiece 14 of the illustrated example is disposed in the vessel 20 in such a manner that the openings 36 are generally directed towards (e.g., pointed towards) to the funnel-shaped base 24 of the vessel 20. A fluid 18 that flows via the line ducts 46 from the fluid vessel 44 into the cavity 38 of the workpiece 14 can reach the outlet 26 of the vessel 20 through the openings 36 of the cavity 38 by adapters 34 that are adapted to the workpiece body 32 of the workpiece 14, without the fluid flowing across external surfaces of the workpiece 32. In some examples, it can, thus, be likely or guaranteed that during the treatment of a workpiece 14 in the workpiece receptacle region 30 of the process chamber, little or no dirt particles of the interior of the cavity 38 reach or contact the external surfaces of the workpiece body 32, which can lead to contamination of the aforementioned surfaces. The equipment 510 of the illustrated example includes a ventilation valve 94 that communicates with the line duct 46 and enables ventilation of the process chamber 12 via the interior of the cavity 38 in the workpiece 14. In some examples, when the shut-off valve 65 is closed and the shut-off valve 68 is opened, ambient air can flow abruptly through the cavity 38 of the workpiece 14 into the process chamber 12 via the suction installation 48, where dirt particles 39 that are deposited in the cavity 38 are conveyed in the flow direction that is generally indicated by the arrows 74 out of the cavity 38 toward the funnel-shaped base 24 of the caldron-shaped vessel 20. In turn, the dirt particles 39 are moved through the line duct 78 and into the suction duct 50, and are accumulated within the vacuum vessel 54, in this example.

In some examples, it is to be noted that a wash liquor, a solvent-containing cleaning agent, foam, an acid, a cooling lubricant, and/or oil can be implemented as the process fluid 18 in any of the example equipment described above. However, additionally or alternatively, in some examples, process fluid can also be solid matter. In some examples, gases (e.g., air, etc.) are also suitable for implementation as a process fluid.

It is moreover to be noted that the examples disclosed herein can also extend to such equipment to treat workpieces in which combinations of features of various of the exemplary embodiments described above are to be found.

In summary, the following preferred features of the examples disclosed herein are to be described in particular. The examples disclosed herein relate to equipment 10, 110, 210, 310, 410, 510 to treat a workpiece 14 with a process fluid 18, where the workpiece 14 includes a cavity 38 that extends from a first opening 36 to a second opening 70. The example equipment 10, 110, 210, 310, 410, 510 includes a line system for providing (e.g., infeeding) the process fluid 18, where the line system has at least one line duct 46 with an adapter for connecting the line system to the at least one cavity 38, where the adapter is adapted to the workpiece body 32. According to the examples disclosed herein, the equipment 10, 110, 210, 310, 410, 510 include a process chamber 12 to receive the workpiece 14 in treatment, where the process chamber 12 includes an outlet 26 to discharge a process fluid 18 that has been induced into the cavity 38 to treat the workpiece 14.

It is an object of the examples disclosed herein to provide equipment to treat workpieces with a process fluid, where the workpieces include a workpiece body having at least one cavity that extends from a first opening to a second opening, in which not only the walls of cavities of the workpiece but also other surfaces of the workpiece can be impinged with the process fluid.

This object can be achieved by equipment having the features of claim 1, and by a method having the features of claim 11. Advantageous embodiments of the examples disclosed herein are specified in other examples described herein.

According to the examples disclosed herein, a process chamber is to receive the workpiece in treatment in the equipment, where the process chamber includes an outlet to discharge a process fluid for treating the workpiece that has been induced into the cavity.

An equipment according to the examples disclosed herein can be conceived, in particular, as equipment to clean workpieces that have a workpiece body with at least one cavity that extends from a first opening to a second opening. In such equipment, for example, it is possible for surfaces of the at least one cavity of the workpieces, as well as surfaces that lie on the outside of the workpieces to be cleaned.

According to the examples disclosed herein, water, wash liquor, and/or solvent-containing cleaning agents can be implemented as a process fluid in equipment according to the examples disclosed herein. The process fluid can, however, also be implemented as foam, as acid, as a cooling lubricant, and/or an oil. In some examples, solids, such as ice pellets, salts, microbubbles, granules, or else gases (e.g., air, etc.), can also be employed as a process fluid in equipment according to the examples disclosed herein.

In one example according to the examples disclosed herein of the equipment, there is, preferably, a suction installation to generate negative pressure. The suction installation is coupled to the process chamber by a suction duct to suction the process fluid from a fluid vessel through the at least one line duct and the at least one cavity into the process chamber. As a result, a suction installation can have a very high relative suction output, by which very large quantities of a process fluid can be moved in a relatively short time (e.g., the shortest time) to be provided.

In some examples, the suction device can include a vacuum vessel that communicates with the suction duct, and an evacuation device to evacuate the vacuum vessel.

In the case of one preferred example of the equipment, it is provided that there is a connection duct that communicates with the at least one line duct and provides the process fluid into the at least one line duct that is connected to a fluid vessel and to discharge process fluid from the process chamber that is connected to the vacuum vessel. In some examples, the connection duct includes a first valve to selectively release and shut off the process fluid provided into the process chamber from the fluid vessel, and contains a second valve for selectively connecting and separating the vacuum vessel and the process chamber.

In the context of the examples disclosed herein it is moreover proposed for the equipment to optionally include an additional line duct that communicates with the outlet of the process chamber and the vacuum vessel. The line duct can include a shut-off valve for selectively releasing and precluding a fluid flow between the process chamber and the vacuum vessel through the further line duct.

It can, thus, be achieved that the at least one cavity of a workpiece that is disposed in the process chamber can be perfused by the process fluid in mutually opposed directions. As a result, a cleaning effect of the process fluid is significantly improved by reversing the flow direction, thereby releasing or entraining contaminants that can be jammed or deposited on constrictions or undercuts by reversal of the flow.

In some examples, it is advantageous for the suction duct in the equipment to communicate with the outlet of the process chamber and the vacuum vessel, where a shut-off valve to selectively release and preclude a fluid flow through the suction duct between the process chamber and the vacuum vessel is disposed in the suction duct.

In some examples, the vacuum vessel for discharging a process fluid, preferably, includes an outlet that is closable by a shut-off valve. The equipment can also include an installation to impinge the at least one cavity in the workpiece in the process chamber with at least one nozzle jet that is composed of a medium from the following group: a process fluid, in particular a liquid medium, steam, a gaseous medium, ice pellets, abrasives. Alternatively or additionally, an installation to impinge the process chamber with a gaseous fluid (e.g., compressed air) can be provided in the equipment. For an improved cleaning effect to be achieved, it is advantageous in some examples for the equipment to have an installation to impinge the at least one workpiece in the process chamber with ultrasound and/or ultrasound signals.

According to a method in accordance with the examples disclosed herein to treat a workpiece with a process fluid, the workpiece includes a workpiece body having at least one cavity that extends from a first opening to a second opening, where the workpiece is to be treated in a first step is disposed in a process chamber. In some examples, the process fluid in a second step is then suctioned into the process chamber through at least one cavity in the workpiece, where the surface of the workpiece in the cavity and external surfaces of the workpiece are impinged with the process fluid.

In that the process fluid in a further method step is released again from the process chamber through the at least one cavity in the workpiece, it can be achieved that the wall faces of the at least one cavity can be exposed to the incident flow of the process fluid from different flow directions, for example.

In some examples, it is advantageous for the workpiece in the process chamber to be disposed in such a manner that the second opening of the workpiece body is located on a side of the workpiece that faces an outlet of the process chamber, where the process fluid in the process chamber flows through the first opening and the cavity to the second opening of the workpiece body. It can, thus, be achieved that dirt particles and contaminants in the treatment of a workpiece in the process chamber cannot reach the external surfaces of a workpiece body of the workpiece.

In order for a high flow velocity of the process fluid through the at least one cavity in the workpiece to be likely or guaranteed in some examples, it is advantageous when the process fluid is urged out of the process chamber by way of a gaseous fluid (e.g., compressed air, etc.).

In some examples, the at least one cavity in the workpiece body can also be impinged with a pressurized gaseous fluid (e.g., compressed air, etc.) once the process fluid has been released from the process chamber. Alternatively or additionally, it is possible a fluid medium can be injected into the at least one cavity in the process chamber, for example.

An example set of equipment 10 for treating a workpiece 14 with a process fluid 18, said workpiece 14 having a workpiece body 32 having at least one cavity 38 that extends from a first opening 36 to a second opening 70, said set of equipment 10 having a line system for infeeding the process fluid 18, said line system having at least one line duct 46 having an adapter 34 for connecting the line system to the at least one cavity 38, and having a process chamber 12 for receiving the workpiece 14 in treatment, said process chamber 12 having an outlet 26 for discharging a process fluid 18 that for treating the workpiece 14 has been induced into the cavity 38, characterized by a suction installation 48 which for generating negative pressure is connected to the process chamber 12 by a suction duct 50, so as to suction the process fluid 18 from a fluid vessel 44 through the at least one line duct 46 and the at least one cavity 38 into the process chamber 12.

In some examples, the suction installation 48 has a vacuum vessel 54 that communicates with the suction duct 50, and an evacuation device 58 for evacuating the vacuum vessel 54.

In some examples, the example set of equipment further includes a connection duct 42 that communicates with the at least one line duct 46 and for infeeding the process fluid 18 into the at least one line duct 46 is connected to the fluid vessel 44 and for discharging process fluid 18 from the process chamber 12 is connected to the vacuum vessel 54, wherein the connection duct 42 has a first valve 66 for selectively releasing and shutting off the infeed of process fluid 18 into the process chamber 12 from the fluid vessel 44, and a second valve 68 for selectively connecting and separating the vacuum vessel 54 and the process chamber 12.

In some examples, the example set of equipment further includes a further line duct 78 that is connected to the outlet 26 of the process chamber, communicates with the vacuum vessel 54, and includes a shut-off valve 80 for selectively releasing and precluding a fluid flow between the process chamber 12 and the vacuum vessel 54 through the further line duct 78.

In some examples, the suction duct 50 communicates with the outlet 26 of the process chamber 12 and with the vacuum vessel 54, wherein a shut-off valve 65 for selectively releasing and precluding a fluid flow through the suction duct 50 between the process chamber 12 and the vacuum vessel 54 is disposed in the suction duct 50.

In some examples, the vacuum vessel 54 for discharging a process fluid 18 has an outlet 26 that is closable by a shut-off valve 62.

In some examples, the example set of equipment further includes an installation 83 for impinging the at least one cavity 38 in the workpiece 14 with at least one nozzle jet 85 from the group of a process fluid 18, a liquid medium, steam, a gaseous medium, ice pellets, abrasives, wherein the workpiece 14 is disposed in the process chamber 12.

In some examples, the example set of equipment further includes an installation 82 for impinging the process chamber 12 with a gaseous fluid, in particular with compressed air.

In some examples, the example set of equipment further includes an installation 88 for impinging the at least one workpiece 14 in the process chamber 12 with ultrasound.

An example method is used to treat a workpiece 14 with a process fluid 18, said workpiece 14 having a workpiece body 32 having at least one cavity 38 that extends from a first opening 36 to a second opening 70. The example method includes the steps of disposing the workpiece 14 in a process chamber 12, and suctioning the process fluid 18 into the process chamber 12 through the at least one cavity 38 in the workpiece 14 in that negative pressure is produced in the process chamber 12.

In some examples, the example method further includes discharging the process fluid 18 from the process chamber 12 through the at least one cavity 38 in the workpiece 14.

In some examples, the workpiece 14 in the process chamber 12 is disposed in such a manner that the second opening 70 of the workpiece body 32 is located on a side of the workpiece 14 that faces an outlet 26 of the process chamber 12, wherein the process fluid 18 in the process chamber 12 flows through the first opening 36 and the cavity 38 to the second opening 70 of the workpiece body 32.

In some examples, the process fluid 18 is urged out of the process chamber 12 by way of a gaseous fluid, in particular compressed air.

In some examples, the example method further includes impinging the at least one cavity 38 in the workpiece body 32 with a pressurized gaseous fluid, in particular with compressed air, once the process fluid 18 has been discharged from the process chamber 12 and/or a medium, in particular a process fluid 18, has been injected into the at least one cavity 38 in the process chamber 12.

This patent arises as a continuation-in-part of International Patent Application No. PCT/EP2016/050086, which was filed on Jan. 5, 2016, which claims priority to German Patent Application No. 10 2015 203 323, which was filed on Feb. 24, 2015. The foregoing International Patent Application and German Patent Application are hereby incorporated herein by reference in their entireties.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. Equipment to treat a workpiece with a process fluid, the workpiece having a workpiece body with at least one cavity that extends from a first opening to a second opening, the equipment comprising:
a line system for providing the process fluid, the line system having at least one line duct with an adapter for connecting the line system to the at least one cavity;
a process chamber to receive the workpiece in treatment, the process chamber including an outlet to discharge a process fluid that has been induced into the cavity; and
a suction installation to generate negative pressure, the suction installation connected to the process chamber by a suction duct to suction the process fluid from a fluid vessel through the at least one line duct and the at least one cavity into the process chamber.

2. The equipment as defined in claim 1, wherein the suction installation includes a vacuum vessel that communicates with the suction duct, and an evacuation device to evacuate the vacuum vessel.

3. The equipment as defined in claim 2, further including a connection duct that communicates with the at least one line duct and provides the process fluid into the at least one line duct, the connection duct is connected to the fluid vessel and to discharge process fluid from the process chamber, is connected to the vacuum vessel, where the connection duct has a first valve for selectively releasing and shutting off the process fluid flowing into the process chamber from the fluid vessel, and a second valve for selectively connecting and separating the vacuum vessel and the process chamber.

4. The equipment as defined in claim 2, further including a further line duct that is connected to the outlet of the process chamber, the further line duct communicating with the vacuum vessel, and including a shut-off valve for selectively releasing and precluding a fluid flow between the process chamber and the vacuum vessel through the further line duct.

5. The equipment as defined in claim 2, wherein the suction duct communicates with the outlet of the process chamber and with the vacuum vessel, where a shut-off valve for selectively releasing and precluding a fluid flow through the suction duct between the process chamber and the vacuum vessel is disposed in the suction duct.

6. The equipment as defined in claim 2, wherein the vacuum vessel to discharge a process fluid has an outlet that is closable by a shut-off valve.

7. The equipment as defined in claim 1, further including an installation to impinge the at least one cavity in the workpiece with at least one nozzle jet from a group consisting of a process fluid, a liquid medium, steam, a gaseous medium, ice pellets, abrasives, wherein the workpiece is disposed in the process chamber.

8. The equipment as defined in claim 1, further including an installation to impinge the process chamber with a gaseous fluid.

9. The equipment as defined in claim 8, wherein the gaseous fluid includes compressed air.

10. The equipment as defined in claim 1, further including an installation to impinge the at least one workpiece in the process chamber with ultrasound signals.

11. A method for treating a workpiece with a process fluid, the workpiece including a workpiece body having at least one cavity that extends from a first opening to a second opening, the method comprising:
disposing the workpiece in a process chamber; and
suctioning the process fluid into the process chamber through the at least one cavity in the workpiece in that negative pressure is produced in the process chamber.

12. The method as defined in claim 11, further including discharging the process fluid from the process chamber through the at least one cavity in the workpiece.

13. The method as defined in claim 11, wherein the workpiece in the process chamber is disposed in such a manner that the second opening of the workpiece body is located on a side of the workpiece that faces an outlet of the process chamber, wherein the process fluid in the process chamber flows through the first opening and the cavity to the second opening of the workpiece body.

14. The method as defined in claim 12, wherein the process fluid is urged out of the process chamber by way of a gaseous fluid.

15. The method as defined in claim 14, wherein the gaseous fluid, includes compressed air.

16. The method as defined in claim 12, further including impinging the at least one cavity in the workpiece body with a pressurized gaseous fluid once the process fluid has been discharged from the process chamber or a medium has been injected into the at least one cavity in the process chamber.

17. The method as defined in claim 16, wherein the pressurized gaseous fluid includes compressed air.

18. The method as defined in claim 16, wherein the medium includes a process fluid.
